(19) United States
(12) Patent Application Publication
(10) Pub. No.: US 2017/0085747 A1
(43) Pub. Date: Mar. 23, 2017

(54) DIGITAL INFORMATION EDITING APPARATUS, DIGITAL INFORMATION EDITING METHOD, AND NON-TRANSITORY COMPUTER READABLE MEDIUM

(71) Applicant: FUJI XEROX CO., LTD., Tokyo (JP)

(72) Inventor: Masaya Tsumenitsu, Yokohama-shi (JP)

(73) Assignee: FUJI XEROX CO., LTD., Tokyo (JP)

(21) Appl. No.: 15/006,929

(22) Filed: Jan. 26, 2016

(30) Foreign Application Priority Data
Sep. 18, 2015 (JP) 2015-185486

(51) Int. Cl. H04N 1/393; G06F 3/12; H04N 1/32; H04N 1/00

(52) U.S. Cl. CPC H04N 1/393; H04N 1/00204; G06F 3/1208; G06F 3/125; H04N 1/32128; H04N 2201/0094; H04N 2201/0039

(57) ABSTRACT

A digital information editing apparatus includes a receiving unit that receives an output request requesting digital information to be output in accordance with printing block copy information that is stored with block copy attribute information including a size of an image indicated by the printing block copy information being associated with imposition information identifying a layout state of the images indicated by plural pieces of the digital information, an extracting unit that extracts the digital information from the printing block copy information in accordance with the imposition information if the receiving unit has received the output request, and a converting unit that converts a size of an image indicated by the digital information extracted by the extracting unit into the size of the image indicated by the printing block copy information.

### CROSS-REFERENCE TO RELATED APPLICATIONS

This application is based on and claims priority under 35 USC 119 from Japanese Patent Application No. 2015-185486 filed Sep. 18, 2015.

### BACKGROUND

### Technical Field

The present invention relates to a digital information editing apparatus, a digital information editing method, and a non-transitory computer readable medium.

### SUMMARY

According to an aspect of the invention, there is provided a digital information editing apparatus. The digital information editing apparatus includes a receiving unit that receives an output request requesting digital information to be output in accordance with printing block copy information that is stored with block copy attribute information including a size of an image indicated by the printing block copy information being associated with imposition information identifying a layout state of the images indicated by plural pieces of the digital information, an extracting unit that extracts the digital information from the printing block copy information in accordance with the imposition information if the receiving unit has received the output request, and a converting unit that converts a size of an image indicated by the digital information extracted by the extracting unit into the size of the image indicated by the printing block copy information.

### BRIEF DESCRIPTION OF THE DRAWINGS

Exemplary embodiments of the present invention will be described in detail based on the following figures, wherein:

FIG. 1 generally illustrates a digital information editing system including a digital information editing apparatus of an exemplary embodiment;

FIG. 2 is a control block diagram of the digital information editing apparatus of the exemplary embodiment;

FIG. 3 illustrates an image of printing block copy data of a first example of the exemplary embodiment;

FIG. 4A and FIG. 4B illustrate images of the printing block copy data of a second example of the exemplary embodiment;

FIG. 5A illustrates an image of print instruction information of the exemplary embodiment, and FIG. 5B illustrates a table of imposition information and the meaning of items thereof;

FIG. 6 is a functional block diagram illustrating a digital information output process that the digital information editing apparatus of the exemplary embodiment performs on the imposed printing block copy data;

FIG. 7 is a control flowchart illustrating a page-based image output control process that the digital information editing apparatus of the exemplary embodiment performs on the imposed printing block copy data that; and

FIG. 8A is a front view of images of copied printing block copy data in the second example of the exemplary embodiment, and FIG. 8B is a front view of images that are extracted from the printing block copy data of FIG. 8A.

### DETAILED DESCRIPTION

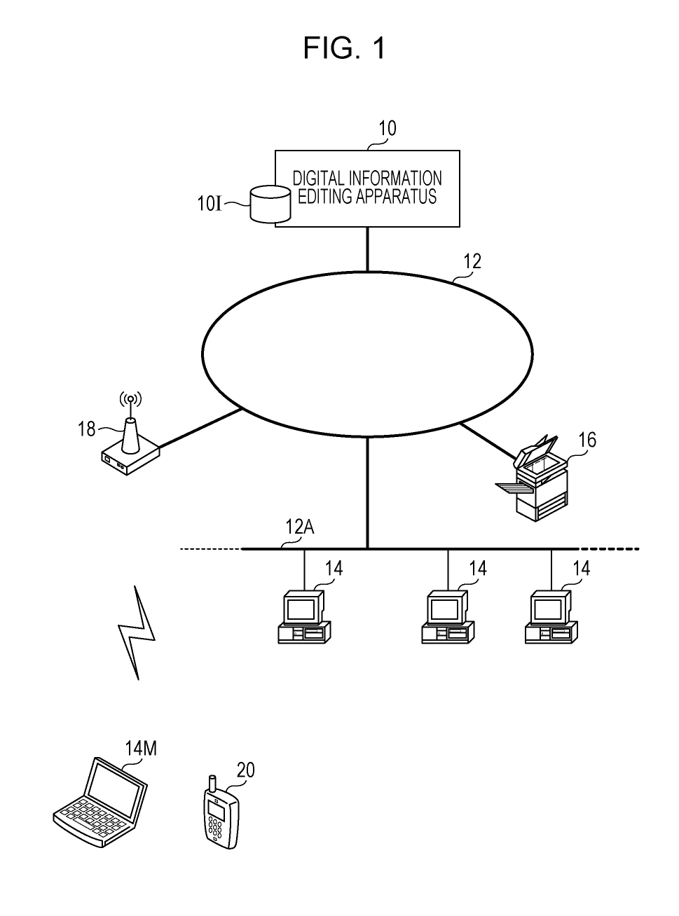

FIG. 1 illustrates a digital information editing apparatus 10 of an exemplary embodiment. The digital information editing apparatus 10 is connected to a communication network 12.

The term digital information is intended to mean characters, graphics, images, illustrations, pictures, photographs, and a combination thereof, and collectively refers to all kinds of digitized electronic information.

The communication network 12 is a local area network (LAN), for example, and may include plural LANs that are interconnected through a wide area network (WAN). The entire communication network including the communication network 12 may not necessarily have to be wire-connected. In other words, the communication network 12 may be a wireless communication network in which information is transmitted or received partly or entirely in a wireless fashion.

Plural personal computers (PCs) 14 are connected to a branch line 12A of the communication network 12 for users to read document information from the digital information editing apparatus 10 and work on the read document information (including viewing or editing the document). Each PC 14 is operated by a respective user. The user, having a predetermined access right, gains access to the digital information editing apparatus 10.

The communication network 12 connects to an image processing apparatus 16 as an output device.

The image processing apparatus 16 has a function of forming (printing) an image in response to receiving document information from a remote PC 14. The image processing apparatus 16 also has a function of performing a copying operation, a scanning (image reading) operation, or a facsimile transmission and reception operation when a user stands in front of the image processing apparatus 16 and performs a variety of operations on the image processing apparatus 16. Document information scanned (image read) may be transmitted to the digital information editing apparatus 10 or a scan server and then stored there as a document file.

The image processing apparatus 16 of FIG. 1 has an external view for office use. In the printing industry, a core printing press for business use capable of outputting a vast amount of printed matter per unit time is used rather than the image processing apparatus 16 for office use. In the discussion that follows, the image processing apparatus 16 refers to all kinds of printers.

A wireless communication device 18 is connected to the communication network 12. The wireless communication device 18 may communicate with a PC 14M taken away to a remote place (hereinafter referred to as a remote PC14M), or a communication mobile terminal 20 (smart phone or cellular phone).

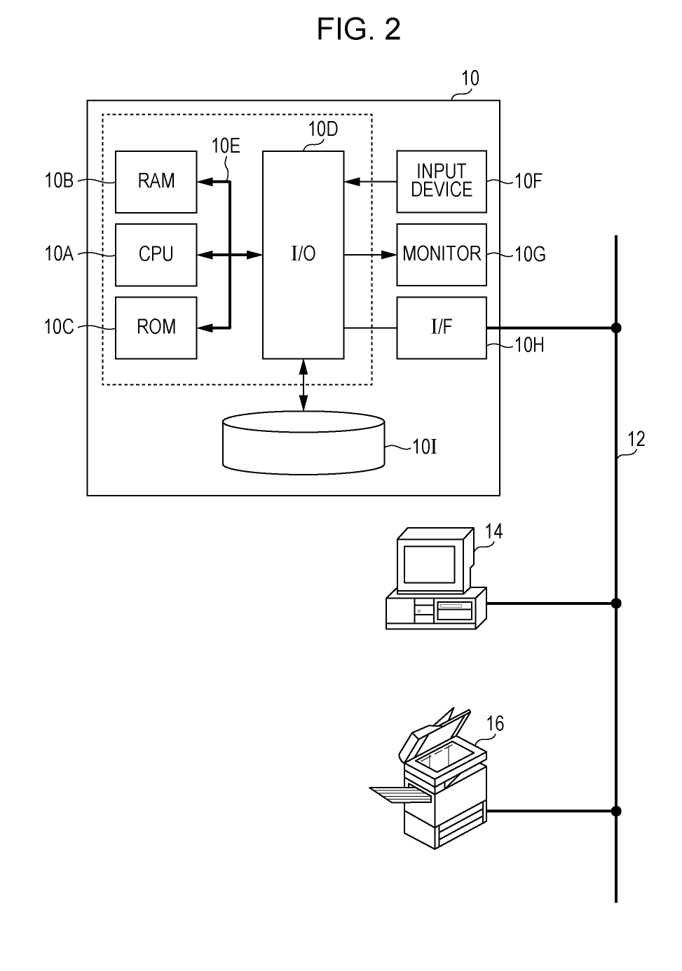

FIG. 2 illustrates a control block diagram of the digital information editing apparatus 10.

The digital information editing apparatus 10 includes a central processing unit (CPU) 10A, a random-access memory (RAM) 10B, a read-only memory (ROM) 10C, an input and output (I/O) unit 10D, and a bus 10E, such as a data bus or a control bus, configured to connect these elements.

An input device 10F, including a keyboard or a mouse, and a monitor 10G are connected to the I/O unit 10D, as appropriate. The I/O unit 10D is connected to the communication network 12 via an interface (I/F) 10H.

Also connected to the I/O unit 10D is a hard disk (HDD) 10I as a large-scale recording device. The hard disk 10I works as a server that stores storage data (to be discussed below) of the exemplary embodiment.

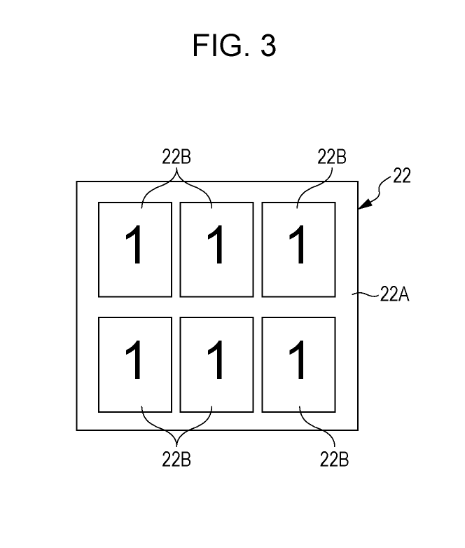

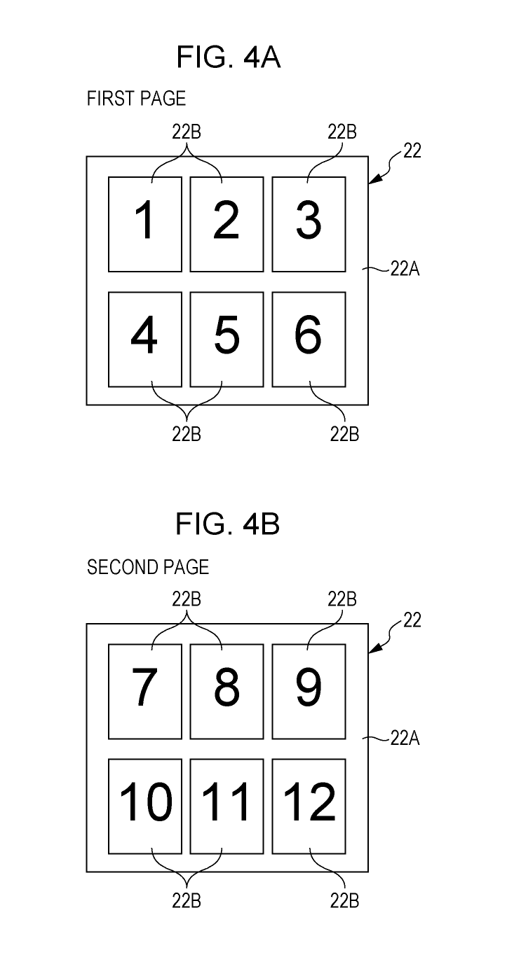

As illustrated in FIG. 3 and FIG. 4A and FIG. 4B, the digital information editing apparatus 10 of the exemplary embodiment has a function of storing, as digital information recognized as a page, printing block copy data 22 (printing block copy information) in which plural images are imposed as an object. The printing block copy data 22 is data in practice. Referring to FIG. 3 and FIG. 4A and FIG. 4B, the printing block copy data 22 is represented as an image in which plural images 22B (original images) are laid out in appropriate locations on an area 22A that is likened to a paper sheet.

### Example of Printing Block Copy Data

### First Example

In the exemplary embodiment, high-volume printing may be performed, like poster printing, as illustrated in FIG. 3. Plural and identical images 22B as the digital information (image labeled “1” is the image 22B as illustrated in FIG. 3) are imposed on the printing block copy data 22 having a predetermined size (media size). The printing block copy data 22 thus results.

In response to a print request, the image processing apparatus 16 reads and prints the printing block copy data 22 in accordance with print instruction information (job ticket), and printed matter of the number of print sheets multiplied by the number of impositions is obtained by cutting the print output according each image 22B.

### Second Example

As illustrated in FIG. 4A and FIG. 4B, booklet binding or bookbinding is performed. In the exemplary embodiment, images 22B of each page are imposed on an area 22A having a predetermined size (media size) to obtain the printing block copy data.

The imposition location of the image is determined in accordance with folding information of booklet or book binding, and may or may not be in the page order. For example, the image processing apparatus 16 reads and prints the printing block copy data 22 in accordance with the print instruction information (job ticket), and folds the printed matter in accordance with folding information. A booklet or book is thus book-bound.

Referring to FIG. 4A and FIG. 4B, images 22B for six pages are imposed on the printing block copy data 22. Different images 22B are imposed on the printing block copy data 22 having a predetermined size (media size). The images 22B of a first page labeled “1” through “6” are imposed as illustrated in FIG. 4A, and the images 22B of a second page labeled “7” through “12” are imposed as illustrated in FIG. 4B.

### Storage State of Printing Block Copy Data

The digital information editing apparatus 10 of the exemplary embodiment stores the printing block copy data 22 of the first example or the second example subsequent to the printing operation, as is, rather than after decomposing the printing block copy data 22 into the original image information of each original page. For example, the printing block copy data 22 is stored as portable document format (PDF) data.

In other words, the original image information is managed on a per image basis before the production of the printing block copy data 22 of the first example or the second example. In the printing block copy data 22 (PDF data), each image is recognized as an object, and is stored, together with media information as block copy attribute information, in an associated state with the print instruction information (job ticket). An operation of linking one piece of information with another piece of information is collectively referred to as “associating”.

The reason why the printing block copy data 22 is stored as is that this printing operation leads to a high printing efficiency in comparison with a printing operation in which printing is performed by imposing each image on each page in re-printing operation.

The media information includes information concerning a size of the area 22A of the printing block copy data 22 (media size), and the number of sheets (the number of pages).

The print instruction information includes information concerning a condition item under which the imposed printing block copy data 22 is printed.

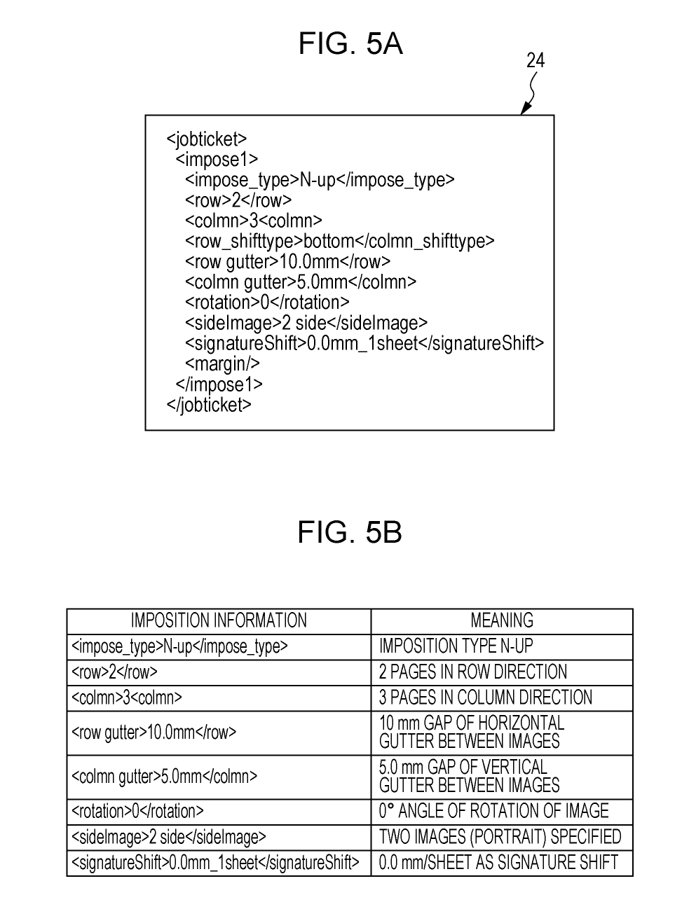

When the printing block copy data 22 is stored, the digital information editing apparatus 10 of the exemplary embodiment attaches imposition information, which is normally discarded because of being unnecessary for re-printing, to print instruction information 24 (see FIG. 5A) as part the print instruction information 24. FIG. 5B illustrates the imposition information and the meaning thereof.

The print instruction information of the exemplary embodiment is a description language of FIG. 5A, and is stored in a state associated with the printing block copy data 22. The print instruction information is information in practice, but instruction items of the print instruction information are illustrated as an image as in FIG. 5B. In the discussion that follows, the printing block copy data 22, the media information, the print instruction information (the imposition information attached to the print instruction information in the exemplary embodiment) to be stored on a hard disk 10I of the digital information editing apparatus 10 are collectively referred to as storage data.

### Read Request by Original Image Unit

A request to read the printing block copy data 22 may be made by a unit of original image, separately from a request to re-print.

As an example, the image of each page may be displayed like a digital book using a viewer function of the PC 14 (14M) or the communication mobile terminal 20 (see FIG. 1).

As another example, the image processing apparatus 16 may print the page of each page.

When the request to read is made on the unit of original image, it is possible in an comparative example that a user visually selects a specific area and extracts an image on a per original image basis after reading the printing block copy data 22.

In contrast, if a request to display each original image or a request to print each original image is received concerning the imposed printing block copy data 22, the digital information editing apparatus 10 of the exemplary embodiment acquires the imposition information that has been attached to the print instruction information associated with the printing block copy data 22. The digital information editing apparatus 10 sets the image of each page to look like having the media size, and then outputs (displays or prints, for example) the set image.

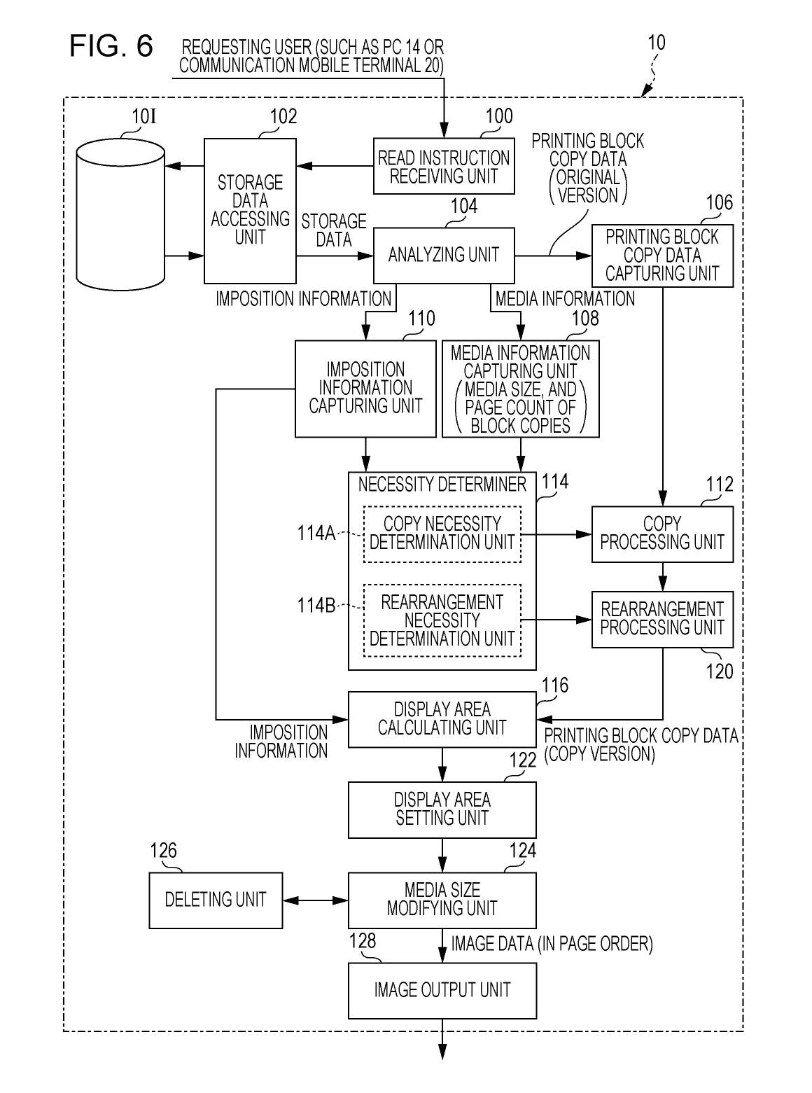

FIG. 6 is a functional block diagram illustrating a digital information output process that the digital information editing apparatus 10 of the exemplary embodiment performs on the imposed printing block copy data 22.

The block diagram of FIG. 6 is illustrated in terms of function, and is not intended to limit a hardware configuration of the digital information editing apparatus 10.

Referring to FIG. 6, a read instruction receiving unit 100 as a receiving unit is configured to receive a read instruction of the imposed printing block copy data 22 from the PC 14 or 14M, or the communication mobile terminal 20 (see FIG. 1).

Since the printing block copy data 22 is associated with the print instruction information as described above, the printing block copy data 22 and the print instruction information are collectively referred to as “storage data”.

The read instruction receiving unit 100 is connected to a storage data accessing unit 102 as an extracting unit. Upon receiving the read instruction, the read instruction receiving unit 100 outputs an identification code of the storage data to the storage data accessing unit 102 to instruct the storage data accessing unit 102 to read the storage data responsive to the identification code.

The storage data accessing unit 102 searches for and reads the storage data responsive to the identification code from the hard disk 10I, and then outputs the storage data to an analyzing unit 104.

The analyzing unit 104 analyzes the read storage data, and separates the storage data into the printing block copy data 22 and the print instruction information. The analyzing unit 104 further separates the media information and the imposition information from the print instruction information. The media information includes information of the size of the printing block copy data 22 (media size), and the number of sheets.

The analyzing unit 104 is connected to a printing block copy data capturing unit 106, a media information capturing unit 108, and an imposition information capturing unit 110.

The printing block copy data capturing unit 106 captures the printing block copy data 22 separated by the analyzing unit 104, and then transfers the printing block copy data 22 to a copy processing unit 112.

The media information capturing unit 108 captures the media information (part of the print instruction information) separated by the analyzing unit 104 and then transfers the media information to a necessity determiner 114.

The imposition information capturing unit 110 captures the imposition information (part of the print instruction information) separated by the analyzing unit 104 and then transfers the imposition information to the necessity determiner 114 and a display area calculating unit 116.

A necessity determiner 114 includes a copy necessity determination unit 114A as a first determination unit and a rearrangement necessity determination unit 114B as a second determination unit.

The copy necessity determination unit 114A determines whether the printing block copy data 22 is to be copied or not in view of the media size and the imposition information.

A determination example of the necessity to copy the printing block copy data 22 is described in accordance with the first and second examples described above.

Since the identical images are imposed on the printing block copy data 22 in the first example, it is sufficient if a single image is captured from a sheet (page) of the printing block copy data 22. There is no need to copy the printing block copy data 22.

In the second example, different images are imposed on plural pages. The printing block copy data 22 of the plural images is copied from a sheet (page) of the printing block copy data 22 (hereinafter referred to as copied printing block copy data 22). The copying is to be performed since the image of each page is captured from each piece of the copied printing block copy data 22.

The copy necessity determination unit 114A is connected to the copy processing unit 112 and transfers the determination results of the necessity to copy to the copy processing unit 112.

The copy processing unit 112 transfers to a rearrangement processing unit 120 print image data, copied or without being copied, in response to the determination results of the necessity to copy.

The rearrangement necessity determination unit 114B determines the necessity as to whether the rearrangement is to be performed, based on the determination results of the necessity to copy.

The examples of the rearrangement necessity determination to be performed in the first and second examples are described below.

In the first example, no rearrangement is to be performed because the images are identical to each other.

In the second example, the rearrangement necessity is determined based on the folding information of the print instruction information.

Types of folding include “half fold”, “letter fold”, “6-page accordion”, “quarto”, “8-page parallel”, “accordion fold”, and “cross fold”. In each of the types, the page order may be different or the upside may be down.

The rearrangement necessity determination unit 114B determines the rearrangement necessity of the images based on the folding information.

The rearrangement necessity determination unit 114B is connected to the rearrangement processing unit 120, and outputs the results of the rearrangement necessity determination of the images to the rearrangement processing unit 120.

The rearrangement processing unit 120 performs a rearrangement operation as appropriate on one or more pieces of printing block copy data 22 received from the copy processing unit 112, based on the results of the rearrangement necessity determination of the images.

The rearrangement processing unit 120 is connected to the display area calculating unit 116, and transfers to the display area calculating unit 116 one or more pieces of printing block copy data 22 processed by the rearrangement processing unit 120 (one or more pieces of printing block copy data 22 that are rearranged by the rearrangement processing unit 120 as appropriate).

The display area calculating unit 116 calculates a display area for each piece of the printing block copy data 22 in accordance with the imposition information. The calculation results of the display area calculating unit 116 are transferred to a display area setting unit 122.

The display area setting unit 122 is connected to a media size modifying unit 124 as a converting unit.

The media size modifying unit 124 modifies the display area set by the display area setting unit 122 on a per page (sheet) basis of the printing block copy data 22 to the media size of the original printing block copy data 22.

Each image is rearranged as appropriate, and is thus processed in the page order.

Since the digital information editing apparatus 10 recognizes that the printing block copy data 22 is output in the media size responsive to the print instruction information, each image is modified to look like having the media size of the printing block copy data 22.

The media size modifying unit 124 is connected to a deleting unit 126 and an image output unit 128.

When a specific image of the printing block copy data 22 is modified to the media size, the data other than the specific image is not used. For this reason, the deleting unit 126 deletes unnecessary data. The deleting unit 126 may not have to be used.

The image output unit 128 outputs to a requesting destination the specific images, having the modified media size, in the page order with the top to bottom direction aligned.

Operations of the exemplary embodiment are described below.

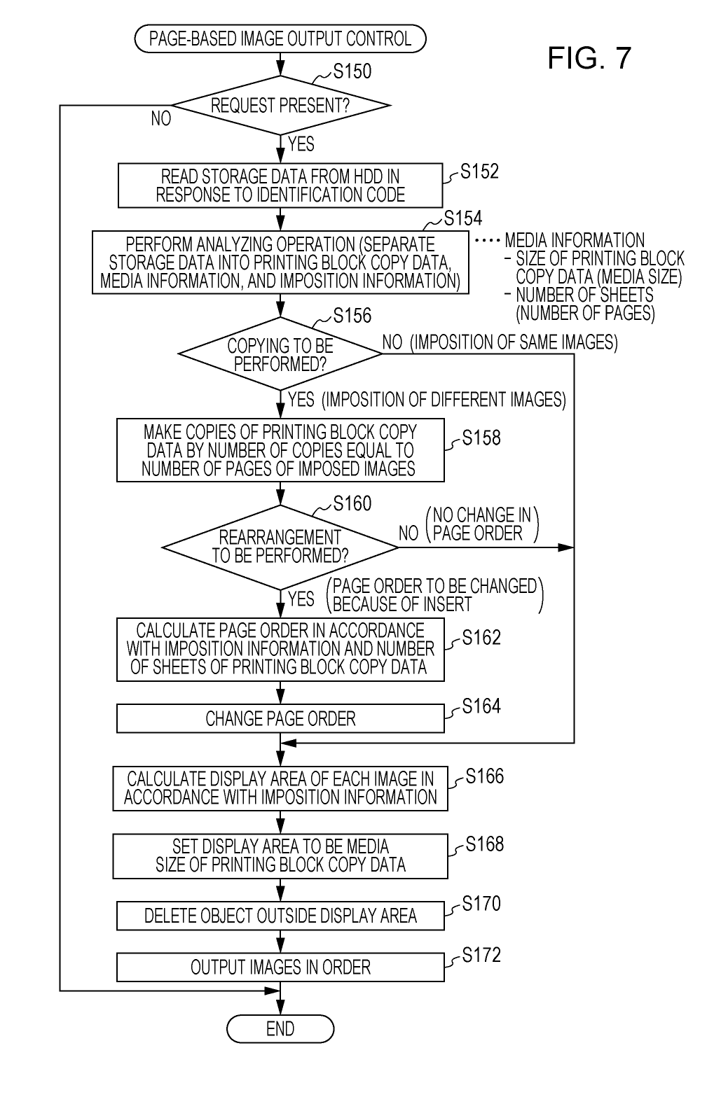

FIG. 7 is a control flowchart illustrating a digital information output process that the digital information editing apparatus 10 of the exemplary embodiment performs on the imposed printing block copy data 22. The CPU 10A performs the process of the control flowchart by reading a digital information editing control program from the ROM 10C of the digital information editing apparatus 10 and by executing the digital information editing control program. The digital information editing control program may be stored on the hard disk 10I or another recording medium.

In step S150, the CPU 10A determines whether there has been a request to output each image 22B from the printing block copy data 22 (such as PDF data) on which plural images are imposed as objects.

If the determination result in step S150 is non-affirmative, this routine ends. If the determination result in step S150 is affirmative, processing proceeds to step S152.

In step S152, the CPU 10A reads from the hard disk 10I (see FIG. 6) the storage data (the printing block copy data 22, the media information, and the print instruction information) in accordance with the identification code that identifies the printing block copy data 22. Processing proceeds to step S154.

In step S154, the CPU 10A analyzes the read storage data, and separates the storage data into the printing block copy data 22, the media information, and the print instruction information, and separates the imposition information from the print instruction information.

In step S156, the CPU 10A determines in accordance with the imposition information whether to make a copy of the printing block copy data 22. If the determination in step S156 is non-affirmative, the CPU 10A determines that the printing block copy data 22 indicates that the printing block copy data 22 is in a form that an identical image is imposed (as in the first example of FIG. 3). Processing proceeds to step S166. The operation in step S166 is described below.

If the determination in step S156 is affirmative, the CPU 10A determines that the image of each page of a booklet or a book is imposed (as in the second example of FIG. 4A and FIG. 4B). Processing proceeds to step S158. The CPU 10A makes the copies of the printing block copy data 22 by the number of pages of imposed images. Processing proceeds to step S160.

In step S160, the CPU 10A determines whether the copied printing block copy data 22 is to be rearranged. If the determination in step S160 is non-affirmative, the CPU 10A determines that the copied printing block copy data 22 is in a fold style that the images are arranged in the page order. Processing proceeds to step S166. The operation in step S166 is described below.

If the determination in step S160 is affirmative, the CPU 10A determines that the copied printing block copy data 22 is in a fold style that the images are not arranged in the page order. Processing proceeds to step S162 where the CPU 10A calculates the page order based on the imposition information and the number of sheets of the printing block copy data 22. Processing proceeds to step S164.

In step S164, the CPU 10A performs an operation to change the order of pages in accordance with the page order calculated in step S162. Processing proceeds to step S166.

In step S166, the CPU 10A calculates a display area and a printing area of each image based on the imposition information. More specifically, the CPU 10A identifies the display area by coordinates that is based on the assumption that the entire plane of the printing block copy data 22 is a two-dimensional plane.

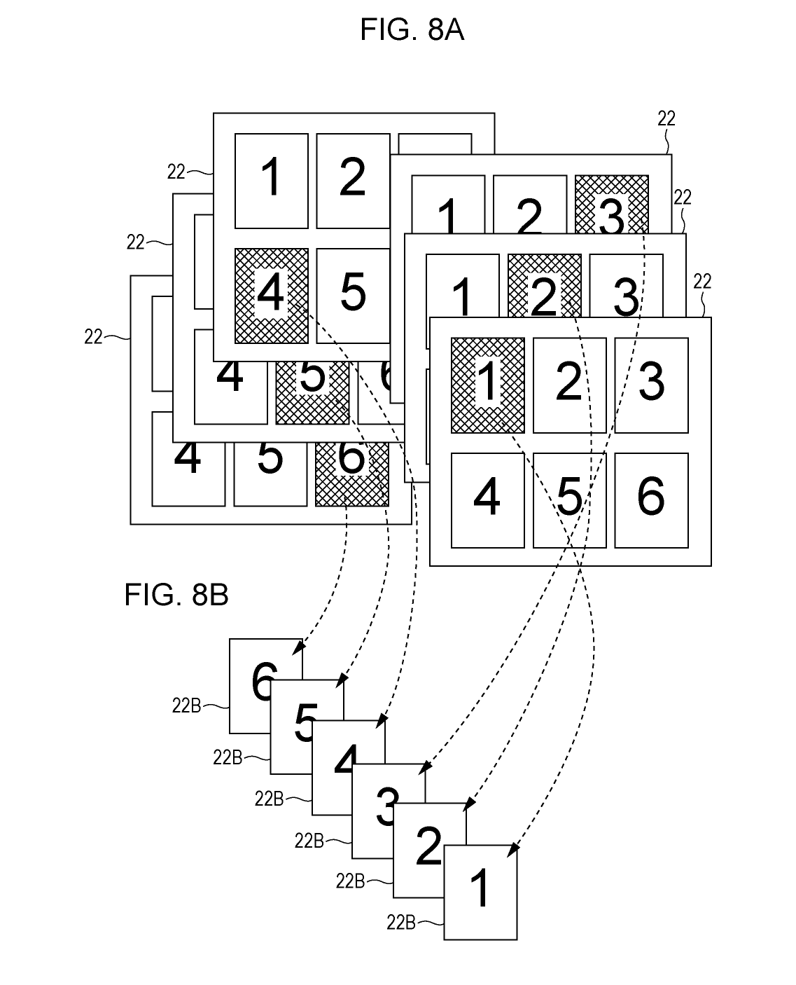

In step S168, the CPU 10A sets the calculated display area or printing area (such as coordinate values) to be the media size that is the whole size of the printing block copy data 22. The CPU 10A proceeds to step S170. In this case, the CPU 10A causes part of the printing block copy data 22 to be recognized as looking like having the media size. Referring to FIG. 8A, for example, the image 22B having the display area or printing area cross-hatched in each piece of copied printing block copy data 22 is an image of the media size.

In step S170, an object outside the display area or printing area is unnecessary data, and is thus deleted. Processing proceeds to step S172. The images of the display area or printing area looking like having the media size are output in the page order (see FIG. 8B). This routine is thus complete.

In accordance with the exemplary embodiment, the CPU 10A acquires the imposition information attached to the print instruction information associated with the printing block copy data 22, sets the image of each page to look like having the media size, and then outputs the image of each page.

The digital information editing apparatus 10 of the exemplary embodiment performs an operation to store the printing block copy data 22 in the form of the PDF data. In the PDF data, the user may select four display areas at four respective locations from a page of the printing block copy data 22 (PDF data) and may then individually extract selected display areas. In the PDF data, the copying may not be involved if the number of images 22 to be imposed on the printing block copy data 22 and to be individually extracted is 4 or less. In other words, the number of copies of images may be smaller than the number of images to be extracted (in the PDF data, the number of copies of images equals a number that results from subtracting 4 from the number of images to be extracted).

The exemplary embodiment includes rotating an upside-down operation in the folding information of the booklet or book. Alternatively, a display rotation function available on the PC 14 (14M) or the communication mobile terminal 20 having requested to read images may be used to adjust the top to bottom direction alignment.

In accordance with the exemplary embodiment, the imposition information remains and is attached to the print instruction information when the storage data including the printing block copy data 22 is stored on the hard disk 10I. Alternatively, the imposition information may be newly generated.

Since the exemplary embodiment is based on the premise that the print instruction information 24 is associated with the printing block copy data 22, the imposition information is attached to the print instruction information 24. If the print instruction information 24 is not used, the imposition information may be associated with the printing block copy data 22, rather than with the print instruction information 24, before being stored.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A digital information editing apparatus comprising:
a receiving unit that receives an output request requesting digital information to be output in accordance with printing block copy information that is stored with block copy attribute information including a size of an image indicated by the printing block copy information being associated with imposition information identifying a layout state of images indicated by a plurality of pieces of the digital information;
an extracting unit that extracts the digital information from the printing block copy information in accordance with the imposition information if the receiving unit has received the output request; and
a converting unit that converts a size of an image indicated by the digital information extracted by the extracting unit into the size of the image indicated by the printing block copy information.

2. The digital information editing apparatus according to claim 1, wherein print instruction information to print the image indicated by the printing block copy information is attached to the stored printing block copy information, and
wherein the imposition information that has been used in storing the printing block copy information is attached to the print instruction information.

3. The digital information editing apparatus according to claim 1, wherein print instruction information to print the image indicated by the printing block copy information is attached to the stored printing block copy information comprises, and
wherein when the printing block copy information is stored, new imposition information is generated, and attached to the print instruction information.

4. The digital information editing apparatus according to claim 1, wherein the extracting unit comprises a first determination unit that determines whether copying of the printing block copy information is to be performed by a number of copies equal to a number of images indicated by the digital information based on the imposition information, and
wherein if the first determination unit determines that the copying is to be performed and the printing block copy information is copied, images of a number indicated by the digital information smaller than the number of images indicated by the copied printing block copy information are extracted with respect to each image indicated by the copied printing block copy information.

5. The digital information editing apparatus according to claim 2, wherein the extracting unit comprises a first determination unit that determines whether copying of the printing block copy information is to be performed by a number of copies equal to a number of images indicated by the digital information based on the imposition information, and
wherein if the first determination unit determines that the copying is to be performed and the printing block copy information is copied, images of a number indicated by the digital information smaller than the number of images indicated by the copied printing block copy information are extracted with respect to each image indicated by the copied printing block copy information.

6. The digital information editing apparatus according to claim 3, wherein the extracting unit comprises a first determination unit that determines whether copying of the printing block copy information is to be performed by a number of copies equal to a number of images indicated by the digital information based on the imposition information, and
wherein if the first determination unit determines that the copying is to be performed and the printing block copy information is copied, images of a number indicated by the digital information smaller than the number of images indicated by the copied printing block copy information are extracted with respect to each image indicated by the copied printing block copy information.

7. The digital information editing apparatus according to claim 1, wherein the extracting unit comprises a first determination unit that determines whether copying of the printing block copy information is to be performed by a number of copies equal to a number of images indicated by the digital information based on the imposition information, and
wherein if the first determination unit determines that the copying is to be performed and the printing block copy information is copied, a piece of the digital information is extracted with respect to each image indicated by the copied printing block copy information.

8. The digital information editing apparatus according to claim 2, wherein the extracting unit comprises a first determination unit that determines whether copying of the printing block copy information is to be performed by a number of copies equal to a number of images indicated by the digital information based on the imposition information, and
wherein if the first determination unit determines that the copying is to be performed and the printing block copy information is copied, a piece of the digital information is extracted with respect to each image indicated by the copied printing block copy information.

9. The digital information editing apparatus according to claim 3, wherein the extracting unit comprises a first determination unit that determines whether copying of the printing block copy information is to be performed by a number of copies equal to a number of images indicated by the digital information based on the imposition information, and
wherein if the first determination unit determines that the copying is to be performed and the printing block copy information is copied, a piece of the digital information is extracted with respect to each image indicated by the copied printing block copy information.

10. The digital information editing apparatus according to claim 1, wherein the extracting unit comprises a second determination unit that determines whether the images are to be rearranged in a page order attached to the digital information in accordance with the imposition information of the printing block copy information,
wherein if the second determination unit determines that a rearrangement is to be performed, the images indicated by the copied printing block copy information are rearranged in accordance with the imposition information.

11. The digital information editing apparatus according to claim 2, wherein the extracting unit comprises a second determination unit that determines whether the images are to be rearranged in a page order attached to the digital information in accordance with the imposition information of the printing block copy information,
wherein if the second determination unit determines that a rearrangement is to be performed, the images indicated by the copied printing block copy information are rearranged in accordance with the imposition information.

12. The digital information editing apparatus according to claim 3, wherein the extracting unit comprises a second determination unit that determines whether the images are to be rearranged in a page order attached to the digital information in accordance with the imposition information of the printing block copy information,
wherein if the second determination unit determines that a rearrangement is to be performed, the images indicated by the copied printing block copy information are rearranged in accordance with the imposition information.

13. The digital information editing apparatus according to claim 4, wherein the extracting unit comprises a second determination unit that determines whether the images are to be rearranged in a page order attached to the digital information in accordance with the imposition information of the printing block copy information,
wherein if the second determination unit determines that a rearrangement is to be performed, the images indicated by the copied printing block copy information are rearranged in accordance with the imposition information.

14. The digital information editing apparatus according to claim 5, wherein the extracting unit comprises a second determination unit that determines whether the images are to be rearranged in a page order attached to the digital information in accordance with the imposition information of the printing block copy information,
wherein if the second determination unit determines that a rearrangement is to be performed, the images indicated by the copied printing block copy information are rearranged in accordance with the imposition information.

15. The digital information editing apparatus according to claim 6, wherein the extracting unit comprises a second determination unit that determines whether the images are to be rearranged in a page order attached to the digital information in accordance with the imposition information of the printing block copy information,
wherein if the second determination unit determines that a rearrangement is to be performed, the images indicated by the copied printing block copy information are rearranged in accordance with the imposition information.

16. The digital information editing apparatus according to claim 7, wherein the extracting unit comprises a second determination unit that determines whether the images are to be rearranged in a page order attached to the digital information in accordance with the imposition information of the printing block copy information,
wherein if the second determination unit determines that a rearrangement is to be performed, the images indicated by the copied printing block copy information are rearranged in accordance with the imposition information.

17. The digital information editing apparatus according to claim 8, wherein the extracting unit comprises a second determination unit that determines whether the images are to be rearranged in a page order attached to the digital information in accordance with the imposition information of the printing block copy information,
wherein if the second determination unit determines that a rearrangement is to be performed, the images indicated by the copied printing block copy information are rearranged in accordance with the imposition information.

18. The digital information editing apparatus according to claim 9, wherein the extracting unit comprises a second determination unit that determines whether the images are to be rearranged in a page order attached to the digital information in accordance with the imposition information of the printing block copy information,
wherein if the second determination unit determines that a rearrangement is to be performed, the images indicated by the copied printing block copy information are rearranged in accordance with the imposition information.

19. A digital information editing method comprising:
receiving an output request requesting digital information to be output in accordance with printing block copy information that is stored with block copy attribute information including a size of an image indicated by the printing block copy information being associated with imposition information identifying a layout state of the images indicated by a plurality of pieces of the digital information;
extracting the digital information from the printing block copy information in accordance with the imposition information if the output request has been received; and
converting a size of an image indicated by the extracted digital information into the size of the image indicated by the printing block copy information.

20. A non-transitory computer readable medium storing a program causing a computer to execute a process for editing information, the process comprising:
receiving an output request requesting digital information to be output in accordance with printing block copy information that is stored with block copy attribute information including a size of an image indicated by the printing block copy information being associated with imposition information identifying a layout state of the images indicated by a plurality of pieces of the digital information;
extracting the digital information from the printing block copy information in accordance with the imposition information if the output request has been received; and
converting a size of an image indicated by the extracted digital information into the size of the image indicated by the printing block copy information.
